(19) United States
(12) Patent Application Publication
(10) Pub. No.: US 2014/0110875 A1
(43) Pub. Date: Apr. 24, 2014

(54) COMPOSITE PRODUCT MANUFACTURING SYSTEM AND METHOD

(71) Applicant: ROLLS-ROYCE PLC, London (GB)

(72) Inventor: Bijoysri Khan, Derby (GB)

(21) Appl. No.: 14/055,437

(22) Filed: Oct. 16, 2013

(30) Foreign Application Priority Data
Oct. 18, 2012 (GB) 1218711.8

(51) Int. Cl. B29C 43/58

(52) U.S. Cl. CPC B29C 43/58
USPC 264/40.5; 425/149

(57) ABSTRACT

A method of manufacture of a composite material is provided. The method includes providing a deformable body having substrate and matrix materials on a surface of a first tool. The substrate material is loosely bound by the matrix material and may include a composite pre-form. The relative movement between the first tool and a second tool is controlled so as to apply pressure to the body between opposing surfaces of the first and second tools and thereby debulk and/or consolidate said body. The first or second tool includes a plurality of individually controllable tool elements, the temperature and/or displacement of said elements being controlled to generate a desired profile in said body. An adaptive debulking system and tool are also disclosed.

### BACKGROUND OF THE INVENTION

The present invention relates to the manufacture of composite products, and more particularly, although not exclusively, to the manufacture of composite products having a fibre substrate embedded in a matrix material.

Existing processes for the manufacture of composite materials involve a material deposition process, often referred to as a lay-up process, during which a fibre substrate is positioned/oriented as required for the final product. Conventional techniques for the deposition process include creation of preforms by fibre placement, tape laying/winding, 3D braiding, filament winding, and machine (automated) laying or stitching/weaving.

One common deposition process involves the application of successive layers or plies, particularly when a substrate is pre-impregnated with resin, so as to build up a composite structure to a desired wall thickness.

It is typically necessary to carry out consolidation and/or debulking of the material at set points during the deposition process. Such steps are taken to ensure a desired density and/or volume fraction of the composite product is achieved, at least in part by minimising any voids in the material, as well as to promote the intended substrate orientation and/or geometry. For some materials, typically for materials/components in which a high degree of precision is required, it is standard practice to carry out frequent debulking/consolidation processes. This is particularly the case when accuracy in the external dimensions and/or fibre volume fraction is required.

Conventional consolidation/debulking processes require manual intervention. Vacuum-bagging comprises one such process in which it is necessary to apply suitable breathing material over the lay-up and envelop the lay-up with a vacuum bag prior to application of a pressure gradient thereto. Interim autoclaving of the product may also be used. An example of a conventional process is described in U.S. Pat. No. 4,963,215.

In the manual process the need to perform extra operations at frequent intervals, particularly for a large stack thickness, increases the overall cycle time increases and adds cost to the component. These problems have been addressed in more modern automated manufacturing processes, in which the debulking cycle is incorporated during the lay-up process by applying increased pressure via the head of a lay-up tool during deposition.

However it has been found that, in the automated route, merely increasing the head pressure does not entirely consolidate the plies to a near net shape. This is particularly the case when producing a part with a greater complexity, e.g. a highly tapered structure or parts with 2D curvature, and accordingly a significant degree of expertise is required in order to achieve a suitable (e.g. non-wrinkled) part. Even with the higher pressure and complex path on some complex components, conventional automated lay-up processes will still require a separate debulk cycle.

It is an aim of the present invention to provide a composite product manufacturing system which mitigates at least some of the above identified problems. It may be considered an aim of the invention to provide a process in which any, or any combination, of the composite geometry, fibre volume fraction and/or volume can be better controlled.

### BRIEF SUMMARY OF THE INVENTION

According to a first aspect of the invention there is provided a method of manufacture of a composite material comprising providing a substrate material on a surface of a first tool, the substrate material being provided with a matrix material, controlling relative movement between the first tool and a second tool to apply pressure to the impregnated substrate material between opposing surfaces of the first and second tools and thereby debulk said material, wherein at least one of the first or second tool comprises a plurality of individually controllable tool elements and wherein any, or any combination of, the temperature, pressure and/or displacement of said elements are controlled to generate a desired profile in said impregnated substrate material.

According to a second aspect of the invention, there is provided a composite material manufacturing system comprising a first tool having a first outer surface on which a substrate material within a matrix material can be deposited, a second tool having a second outer surface arranged to oppose the first outer surface, an actuator for moving the first and or second tools so as to apply a compacting pressure to the substrate and matrix materials therebetween, wherein at least one of the first or second tool comprises a plurality of individually controllable tool elements, and a controller arranged to control any, or any combination of the temperature, pressure and/or displacement of said elements so as to generate a desired profile in said impregnated substrate material.

The matrix material may be pre-dispersed throughout the substrate (i.e. prior to placement on the tool). The substrate material may be suspended within or by the matrix material. The substrate material may be impregnated, saturated, wetted, soaked or otherwise held within the matrix material. The matrix material may bind, e.g. loosely, the substrate material. The matrix material may be uncured. The matrix material may be cured or partially cured by raising the temperature of said elements.

The temperature and/or displacement of the individual tool elements may be actively controlled. The temperature and/or displacement of the individual tool elements may be controlled according to an open or closed feedback loop, with respect to time.

The plurality of tool elements may comprise an array of elements, such as, for example a two dimensional array. The array of elements may correspond to locations on the tool surface, for example so that each element corresponds to an area of the tool surface. Each element may be immediately adjacent one or more further elements of the array. Each element may be quadrilateral in section. Each element may be square or rectangular in section.

The tool elements may each have a free end which defines a portion of the shape of the tool surface. The free ends of the elements may themselves define the tool surface or else may be covered by a membrane or plate which defines the tool surface. Such a membrane or plate may comprise a thin-walled structure or may otherwise be sufficiently deformable to allow a surface profile defined by the free ends of the tool elements to be impressed upon an impregnated substrate material in the tool.

The tool elements may be arranged in a two-dimensional array within a first plane. The tool elements may be individually actuatable in a direction substantially perpendicular to said plane.

The temperature of each tool element may be individually controllable. Each tool element may comprise a heater element, such as for example a resistive heating element.

The control of the individual element may comprise initial setting and/or adjustment/updating of operation parameters during production.

A measurement device may be arranged to determine one or more geometrical parameters of the impregnated substrate material on the first tool, for example prior to debulking. The measurement device may determine a height measurement of the impregnated substrate material at a plurality of locations thereon. The measurement device may determine a surface profile for said material. A non-contact measurement device such as a scanner may be use.

The controller may set the position/displacement and/or temperature of the elements based on a measure surface reading/profile of the impregnated substrate material on the first tool. A desired profile or one or more parameters of the composite component to be manufactured may be stored on a memory which is accessible to the controller. The controller may compare the measured surface readings/profile with the stored desired profile. The controller may determine an offset between the stored and measured values and may control the elements based there-upon.

The surface profile may be measured after one, or between successive, debulking processes. The controller may determine whether to adjust the elements between each such process or stage.

One or more sensors may be provided to determine operational parameters during debulking. Sensor readings of operational parameters comprising any, or any combination, of temperature, displacement/position and/or applied load or pressure may be taken during operation of the tool. The controller may adjust the element settings in response thereto, for example in real-time.

The matrix material may comprise a fluid, which may be viscous or visco-elastic or thixotropic. The matrix material typically comprises a hardenable, settable or curable material in a fluid/uncured state. The matrix material may comprise a polymer, such as a thermoplastic or thermosetting plastic. The matrix may comprise a resin.

The substrate may comprise a fibre substrate, which may comprise bundles or tows of fibres which may be arranged in a ply. The impregnated substrate may comprise a plurality of plies, one atop the other so as to define a depth or height of said material. Each layer or tow may be pre-saturated with the matrix material before being laid down in the first tool.

According to a third aspect of the invention, there is provided a composite material manufacturing tool having an outer surface arranged to contact a substrate material impregnated with a matrix material in use and an actuator for pressing said surface against said material, wherein the tool comprises a plurality of individually controllable tool elements, and a controller arranged to control any or any combination of the temperature, pressure and/or displacement of said elements so as to generate a desired profile in said impregnated substrate material.

The elements may be discrete elements, which are individually actuatable. Each element may have an associated/dedicated actuator and/or heater. The elements may be arranged in an array in an abutting, side-by-side relationship, for example such that there is minimal or no gap therebetween.

Any of the features defined above in relation to any one aspect of the invention may be applied to any further aspect.

Debulking, in the context of the present invention includes consolidation and/or reduction of the volume of a composite material by application of contact pressure thereto.

### BRIEF DESCRIPTION OF THE DRAWINGS

Practicable embodiments of the invention are described in further detail below by way of example only with reference to the accompanying drawings, of which:

FIG. 1 shows a three-dimensional view of a tool having a substrate thereon for composite production in accordance with an example of the invention;

FIG. 2 shows a schematic three dimensional view of an example of a measurement arrangement for use with the invention;

FIG. 3 shows a data flow diagram for an example of system operation according to the invention;

FIG. 4 shows a schematic three-dimensional view of a tool actuator according to an embodiment of the invention;

FIG. 5 shows a schematic sectional view through the tool actuator of FIG. 4;

FIG. 6 shows a plan view of an adjustable surface member for a tool according to one example of the invention;

FIG. 7 shows the process steps for processing the substrate material of FIG. 1; and

FIG. 8 shows examples of temperature, displacement and pressure plots over time for one tool actuator or element.

### DETAILED DESCRIPTION OF THE INVENTION

The present invention derives from the understanding that the consolidation process for composite product production is not purely a machine dependent parameter. Accordingly it has been determined that, because corresponding composite lay-ups can differ both between products and due to input material variation, each lay-up should be debulked/consolidated in a bespoke manner in order to achieve a consistent end product. The inventor(s) has determined that the viscoelastic creep/recovery response of the resin determines the degree of debulking and the conformity of the composite to a desired net shape. The profile of the product can change over the debulk period. Accordingly the consolidation pressure applied to the composite preform, including the rate of application thereof, as well as the temperature state of the material can all be adjusted over different areas of the preform to achieve the desired profile of the end product.

Certain aspects of the invention therefore concern the provision of an adaptive tool, or feedback-loop controlled, moulding operation which comprises of a surface mapping of the composite lay-up in order to determine any adjustments to be made to the tool in order to achieve a desired profile of the preform and/or end product.

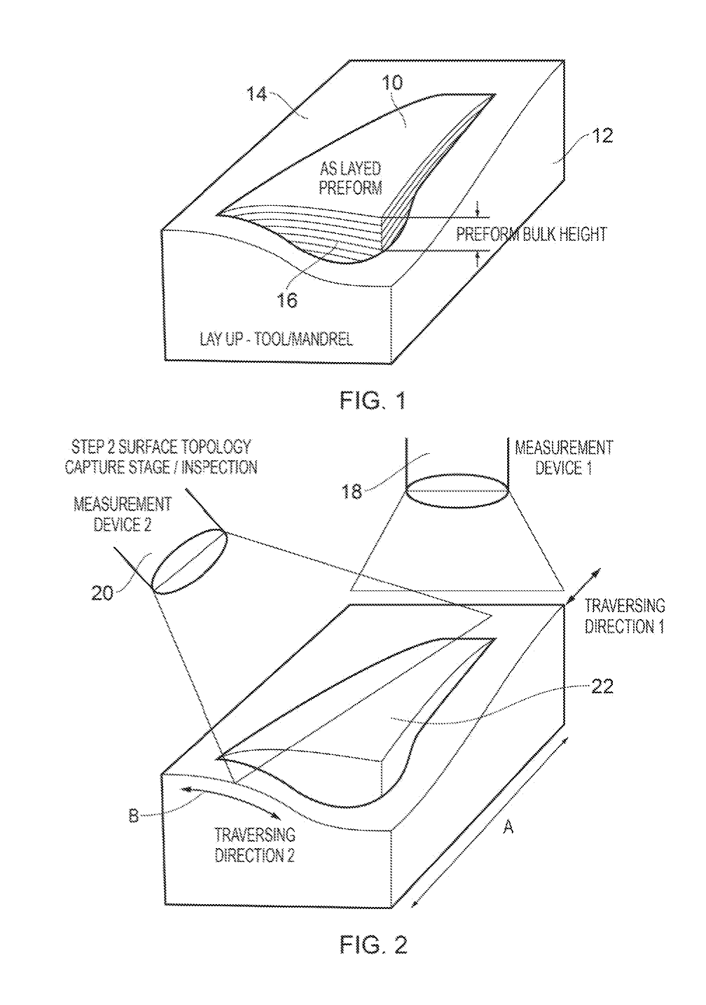

Turning now to FIG. 1, there is shown a first stage in the process, in which a composite material preform 10 has been deposited on a tool 12 or mandrel. The preform 10 comprises a substrate which is pre-impregnated with matrix material.

In this embodiment the tool has a contoured tool surface 14 shaped to apply a desired profile to a surface of the composite product to be produced. Various profiles, including curved surfaces and sharper edges, and/or other complex geometries, can be formed using a correspondingly shaped tool as will be understood by the person skilled in this field.

The preform 10 for the composite material to be produced is deposited on the tool surface 14 by laying down successive plies 16 of composite material. Each layer or ply 16 comprises a conventional arrangement of fibres, which is pre-saturated or impregnated with a conventional matrix material, such as an expoxy resin or other suitable polymer. The first layer 16 is laid upon surface 14 and the subsequent layers are laid down sequentially, each upon the last, in order to build up a stack of layers within the matrix material. Each layer substantially follows the contour of the previous layer such that the outermost layer substantially follows the profile of the underlying tool surface 14.

After a stack of layers 16 have been deposited as shown in FIG. 1, it is necessary to consolidate the stack before adding more plies.

The next stage in accordance with one example of the invention is to determine the surface geometry or topology of the as-laid fibre preform prior to consolidation. This may be achieved using a number of different conventional non-contact scanning or probe devices, comprising, for example, laser scanning, optical measuring, non contact based, ultrasonic or proximity based surface or volumetric based measurement. In one example, position feedback from the ply laying head can also provide basic dimensional data, for example in order to indicate whether consolidation is necessary.

An example of the inspection device is shown in FIG. 2, which shows two measurement devices 18, 20 arranged to scan the surface 22 of the preform 10 on the tool 12. The first 18 and second 20 measurement devices (e.g. scanning heads) determine the variations in the surface height in orthogonal directions. The first head 18 is arranged to traverse or scan the surface in the direction indicated by arrow A, whilst the second head 20 traverses or scans the surface in the direction indicated by arrow B. Such a two-directional scanning system may be used particularly for components with curved surfaces.

Other measurement/scanning methods may be used as be realised by the person skilled in the art.

The surface measurement/topology data is typically acquired and/or stored with reference to a datum feature. Such a datum feature may comprise one or more predetermined locations on the tool surface 14 such that all measurements are taken with reference to a known fixed point. The measurements are typically acquired electronically.

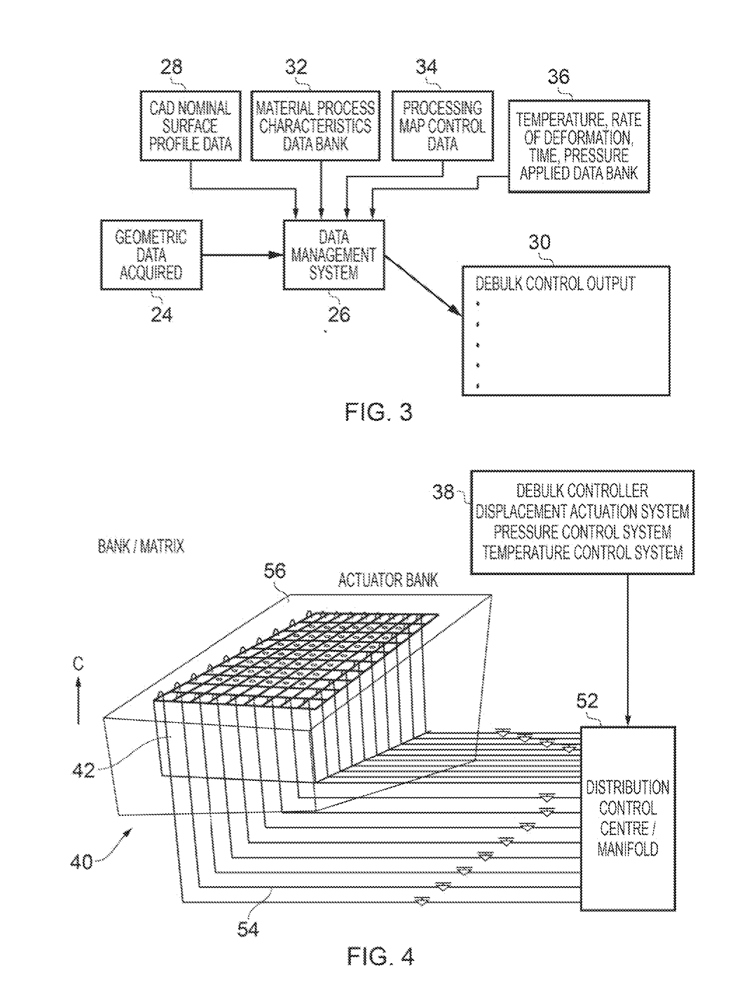

The measurement data 24 is fed to a data store which typically forms a part of a data management and/or processing system 26 as shown in FIG. 3. The system may comprise one or more processors arranged to receive various data inputs, including the measured surface geometric data 24, and to process those inputs in order to determine a suitable control output 28 for debulking/consolidation of the preform material 10.

From the measured data 24, the processing system 26 is able to construct a 3-dimensional surface profile or model for the measured surface 22.

The processing system 26 also receives or accesses a predetermined surface profile or model 28 from a data store which is accessible to the data processing system 26. The predetermined surface profile is indicative of an ideal or desired surface profile, either before or after debulking has taken place. Typically the desired surface profile is the surface profile after debulking and may be a nominal surface profile, for example captured using CAD software.

The processing system 26 determines the difference between the desired surface profile and the measured surface profile. Thus the processing system can determine the degree or amount by which the measured surface profile must be modified in order to achieve the desired surface. Such data may be stored as a series or array of two-dimensional locations in an arbitrary plane and a height value (or variation) at each of said locations. The plane may be a horizontal plane or some other plane (e.g. a section through, or else a plane above or below the pre-form) sufficient to encompass or accommodate a major dimension (e.g. a length and/or width dimension rather than a depth dimension) of the preform 10. Ideally the plane is not orthogonal to the surface 22 but is substantially aligned therewith as far as possible.

The data processing system 26 may have one or more modules of computer-readable code, such as software, comprising one or more algorithms to determine suitable displacement, pressure and/or temperature parameters to apply over regions of the surface 22 in order to achieve the desired surface profile. The software typically also determines a length of time over which to apply the determined parameters and/or a rate at which those parameters should be changed over time in order to achieve the desired surface. In some embodiments, the discrepancy between the measured and nominal surfaces alone is sufficient to allow the processing system 26 to determine a suitable control signal output 30. In such an embodiment the algorithms or control laws may assume that consistent materials are used such that the surface height variation correlates to a defined displacement, pressure and temperature in the debulking tool.

However the viscoelastic creep/recovery response of a resin is highly non-linear. When coupled with multiple degrees of freedom of operational parameters, it will be appreciated that a more suitable method of determining the suitable control parameters may involve interrogation of a material properties data store 32. The data store may comprise records of material properties or behaviour under varying processing conditions, which may be derived, for example, from empirical data. In this manner, multiple different materials can be accommodates, such that the system/tool can be used for varying different product materials and configurations.

The material data store 32 may also receive materials measurement data, e.g. dimensional data, as an input, such as thickness, areal weight, etc.

The data processing system may also access a data store 34 or algorithms for converting the determined processing parameters into control signals 3Q for the debulking tool. A database may additionally or alternatively be maintained which correlates the various operational parameters over suitable ranges, such as temperatures, deformation rates, applied pressures and times, an example of which for one actuator is shown in FIG. 8.

In this embodiment, the processing system 26 may take the form of a computer which derives the appropriate control parameters and produces a debulking control definition for transmission to a debulking tool controller 38 as shown in FIG. 4, for example over a network connection. However in other embodiments, the processing system 26 and debulking tool controller 38 could be one and the same.

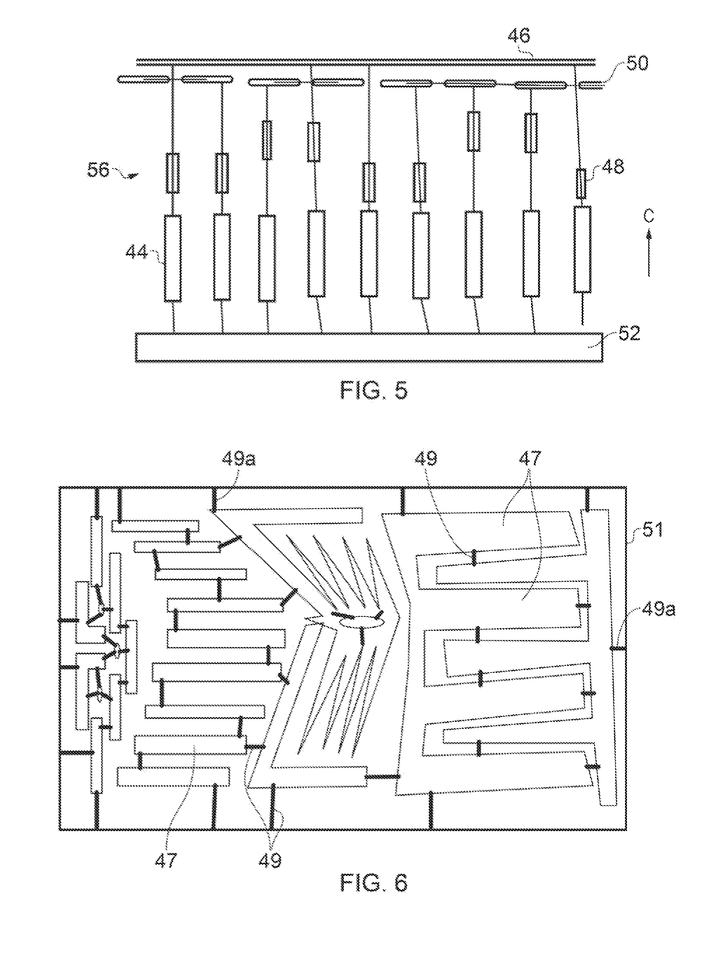

The debulking tool 40 in the example shown in FIGS. 4 and 5 comprises an adaptive debulking hood 56 having an array of elements 42. Each element comprises an actuator 44 as shown in FIG. 5 which is individually controllable by the controller 38. The elements 42 are arranged as a two-dimensional matrix or array which is sufficient in size to accommodate the area of the pre-form in plan.

The location of the elements 42 within the array may be fixed. However the elements 42 are actuatable in a direction substantially perpendicular to the plane or surface of the array, i.e. in the direction C indicated in FIGS. 4 and 5. In other examples, such as for a curved tool, the direction C may be different for each actuator.

Each element has one or more sensors associated therewith, typically incorporated in the actuator assembly 44 or elsewhere in the hood 56, which can be used to determine a current operational state of the element. The sensor readings can then be fed back to the controller 38 during operation in order to allow actuation of each element according to a closed feedback loop. The sensors may comprise any, or any combination, of conventional position, displacement, pressure and/or temperature sensors.

In FIG. 5 there is shown a preferred embodiment in which the position and temperature of each element can be independently controlled. In this embodiment, each element comprises a linear actuator 44 arranged to move relative to an intermediate thin walled member or structure 46. The member 46 is an intermediate contact member for contacting applying a contact pressure to the pre-form in the manner of a caul plate. However in this example, the intermediate member is resiliently deformable or otherwise compliant such that movements of the actuators 44 can deform the caul plate and thereby modify the surface profile thereof. In one embodiment, the caul plate may be formed as a substantially flat or planar member which is deformed from its at-rest condition into a desired surface profile for the pre-form. Alternatively, the caul plate may be formed of a more resilient material which defines a desired or average surface profile for the pre-form. Thus the actuators in use may only need to deform the caul plate by smaller amounts in order to achieve a bespoke, adapted surface for individual pre-forms in use.

In the example of a curved tool, the thin walled member 46 may be similar in shape to the consolidated preform surface 22′.

One example of a flexible caul plate 46 is shown in FIG. 6, which is formed as a series or network of individual plate portions 47 and a plurality of linkage portions 49 therebetween. The linkages 49 are flexible to allow controlled flexing of the caul plate between the plate portions 47, which are relatively stiffer than the linkages.

The plate portions 47 can be tailored for a specific desired geometry and the linkages may be formed so as to offer a consistent or varying resilience between different portions 47. Such a configuration may offer flexion of the caul plate within predefined limits. The vicinity of any deformations may be controlled to occur at discrete points by virtue of the flexible linkage joint system. The caul plate may comprise an outer or peripheral frame 51, which may support the plate portions 47, for example via further linkages or ties 49a. Conventional caul plate and/or stiffener materials may be used.

Interposed between each actuator and the intermediate member 46 is a bearing member 48, through which a load may be applied to the intermediate member. The bearing member may be a resilient member, comprising, for example, an elastomer. This allows the adaptable caul 46 to move without locking or bending the actuator mechanism.

A heater arrangement 50 is provided adjacent, typically in contact with, the intermediate member 46 so as to allow heat transfer between the tool and the pre-form. The heater may comprise an array of individual heaters corresponding to the array of elements. Alternatively the heater may comprise a common heater structure, of which individual portions or regions corresponding to the individual elements 42 can be selectively heated.

In the embodiment of FIG. 5, the heater is provided by a heater mat structure 50 located between the actuator 44 and the intermediate member 46. Individual portions or zones of the heater mat structure 50 are individually controllable to increase or decrease the temperature thereof, for example by resistive heating elements in the mat.

In any embodiment, the heater may be integrated within the tool. It is not essential that the heaters and actuators are aligned in a one-to-one relationship, although such an arrangement may be beneficial to allow correlation of temperature and pressure application to the pre-form in use. Corresponding measurement of the temperatures in the actuators/elements/hood are made to allow full control, for example by monitoring resistance of the heater elements or the use of a heat flux sensor within the intermediate member 46.

In one embodiment it has been found that a high temperature or low heat flux transfer for one or a group of actuators can be indicative of the intermediate layer 46 not being in contact with the component (e.g. that a void is present or that an actuator/mechanism has failed to operate correctly). Thus a signal or alert can be output to indicate such a determination and/or allow corrective action to be implemented via the tool 40.

In the examples of FIGS. 4 and 5, the tool comprises a displacement actuation system, a pressure control system and a temperature control system. Each of those sub-systems may be individually controllable in accordance with the control input received from the controller 38. In this regard, the system comprises a distribution control interface or manifold 52 to allow dissemination of different control signals to the individual elements, such as the heater and/or actuator of each element. A series of wired or wireless connections 54 may be established between the relevant components and the interface 52 for this purpose.

Using the above-described system an adaptive tool can be provided having a bank of underlying actuators and heaters selectively actuatable via a series of connected/disconnected members to change the shape of the pre-form. The heat, applied force/pressure and the rate of actuation are all controlled by the data processing system 26 (either directly or indirectly via debulk controller 38) as dictated by the control law such that the tool can apply variations in temperature and pressure, for example at different rate, over different portions of the tool to effect changes to the moulding of the final composite component to be formed from the pre-form. The tool allows the compaction pressure/temperature to be applied in any sequence as deemed by the control law to achieve the desired quality of the part.

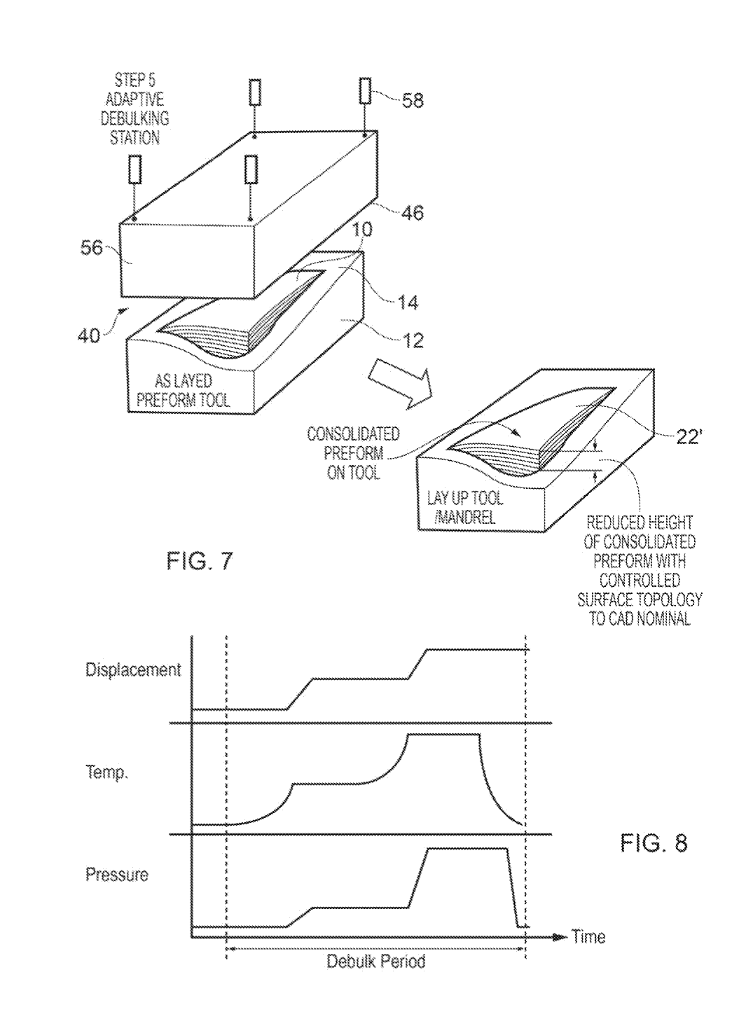

In use, as shown in FIG. 7, the pre-form 10 on the lay-up tool 12, after scanning is placed adjacent the intermediate member or caul plate 46 of the adaptive tool arrangement 56 described above. The pre-form 10 is typically uncured at this point. The lay-up tool and the adaptive tool 56 form opposing portions of the debulking tool used to modify the pre-form. The desired settings for the adaptive tool 56 are determined and the corresponding parameters for the actuators 44 and/or heaters 50 are set.

The lay-up tool 12 and the adaptive hood 56 are then brought together, typically for a predetermined length of time, such that the pre-form is sandwiched between the opposing surfaces 14, 46 of the tool parts. The position and applied pressure of either/both of the lay-up tool 12 and adaptive hood 56 is controlled over that time. The relative orientation of those parts may be controlled by mechanical actuators 58 on the fixtures of the tools, i.e. to control global tool positioning and/or applied pressure. The controller described above may receive position/pressure readings for those actuators 58 and adjust them accordingly.

The controller operates the adaptive debulking hood in the manner described above. The preform can thus be deformed to a varying degree over its surface in contact with the adaptive tool surface. A vacuum may optionally be drawn between the opposing tool surfaces 14 and 46 during the consolidation process.

It is to be noted that the operational parameters for the adaptive tool 56 may have initial set values which may be fixed or else which may change according to a predetermined schedule during processing. Additionally or alternatively, variations in the operational parameters may be made by the controller (i.e. in a transient manner) in response to sensor readings during operation. For example, pressure and/or temperature readings may be fed to the controller and the pressure/temperature at different locations and/or the overall pressure/temperature profile may be compared to desired or predicted settings.

An example of such a profile for one of the actuators/elements 42 is shown in FIG. 8. As can be seen changes in pressure/temperature/displacement can be implemented in sequence (i.e. individually controlled) according to an adaptive method of control. Thus in response to sensing of varying conditions in different regions of the substrate the individual elements can be actively adjusted. For example temperature and/or pressure increases may be delayed or accelerated in one zone (i.e. for one or more elements) relative to another so as to allow adjustment in the substrate profile, whilst delaying curing. Also it is possible that pressure/displacement may be increased or decreased for one or more elements, whilst maintaining a constant temperature or adjusting the temperature in a contrasting manner. Conversely, temperature may be increased or decreased whilst maintaining a constant displacement/pressure (e.g. to accelerate curing once a desired profile is achieved). In this manner the interplay between temperature/displacement/pressure control provides far greater freedom in order to more accurately achieve a desired substrate profile or fibre volume fraction in response to variations in input substrate layups.

Regardless of whether the adaptive debulk tool 56 is controllable only initially before operation, or else is responsive to sensed variations during operation, the tool can offer improved conformity to a desired component geometry, which accommodates variations in the pre-form due to the laying-up process.

The tool of the present invention is typically used to undertake a partial or initial cure for the pre-form only. According to any aspect of the invention, any of the element control/actuation steps (e.g. for consolidation) may be performed during curing.

A component output from the adaptive tool will typically be cured sufficiently such that its geometry is rigid and defined such that the component can then be taken through final cure either in the tool or by transferring the partially cured component to a conventional autoclave. The full cure is typically undertaken by heating the entire component to a predetermined temperature, in contrast to zoned temperature variations which are allowed by a tool according to the present invention. The full cure temperature is typically higher than the consolidation/zoned heating temperature.

At the end of the debulking process the preform is consolidated and achieves a CAD nominal surface topology and may then be subjected to further processing i.e. additional layup. At the end of the lay up process the preform can be reconsolidated following the process step described above and then subjected to final cure operation.

Embodiments of the invention may be summarised as an intelligent morphing tool which responds to the variation in an input condition of a deformable/uncured composite component and produces a defined output by means of an adaptive array of actuators for a component contact surface.

Thus the invention is capable of determining and implementing a deviation in an adaptable composite processing tool to enable deformation of an input composite material as dictated by the geometry of the input material. This differs from conventional global tool setting parameters to allow zoned parameter correction for unacceptable tolerances in preforms during processing thereof. The invention allows feedback and consolidation of the consolidation process to accommodate input material variation. The output (i.e. control adjustments) can provide feedback for the layup system to ensure target fibre-volume fractions are achieved. The present invention can reduce scrap rate as well as being able to control the consolidation of a simple or a highly complex part in a manner which can minimise distortion in components after cure.

The proposed system can also be applied in the process of adaptive drape forming, diaphragm forming vacuum forming or in other specialised areas wherever the shell/tool manipulation is required.

Examples of components to which the invention can be applied include composite aerofoils, vanes, stators, cowling, etc for fluid flow machines, such as gas turbine engines, pumps or the like. The invention may have application for other bulky shaped parts aerospace, marine, automotive or other engineering fields.

Whilst the examples of the invention relate to polymer composites having a fibre substrate, typically comprising long or short glass or carbon fibres, the invention is not so limited and may encompass other composites. Other matrix materials than the resin/polymer materials described above may be used, such as silicon carbide (SiC) and ceramics. Although it is advantageous in some embodiments to use a pre-impregnated substrate, the invention can be performed on dry fibre substrates with a binder. The invention may encompass ceramic matrix composites or the like.

The invention may find particular benefit in allowing prototype product designs to be taken forward into production more quickly.

1. A method of manufacture of a composite material comprising:
providing a deformable body having substrate and matrix materials on a surface of a first tool, the matrix material being dispersed throughout the substrate,
controlling relative movement between the first tool and a second tool to apply pressure to the body between opposing surfaces of the first and second tools and thereby debulk said body,
wherein at least one of the first or second tool comprises a plurality of individually controllable tool elements and wherein the temperature and/or displacement of said elements are controlled during debulking to generate a desired profile in said body.

2. A composite material manufacturing system comprising:
a first tool having a first outer surface on which a deformable body having substrate and matrix materials can be deposited;
a second tool having a second outer surface arranged to oppose the first outer surface, an actuator for moving the first and or second tools so as to apply a compacting pressure to the impregnated substrate material therebetween;
wherein at least one of the first or second tool comprises a plurality of individually controllable tool elements; and
a controller arranged to control the temperature and/or displacement of said elements during debulking so as to generate a desired profile in said impregnated substrate material.

3. A method according to claim 1, wherein the temperature, applied pressure and/or displacement of the individual tool elements is actively controlled according to an open or closed feedback loop.

4. A method according to claim 1, wherein the first and/or second tool comprises any, or any combination, of temperature, pressure and/or displacement sensors for the tool elements and the temperature and/or displacement of said elements is controlled based on readings of said sensors so as to actively adjust debulking of the impregnated substrate during heating thereof.

5. A method according to claim 1, wherein the plurality of tool elements comprise a two dimensional array of elements, each element corresponding to an area of the first or second tool surface.

6. A method according to claim 1, wherein the tool elements are individually actuatable so as to modify the shape of the surface of the first or second tool.

7. A method or system according to claim 6, wherein the surface of said first or second tool is provided by an intermediate member and the elements are individually actuatable to deform the intermediate member.

8. A method or system according to claim 7, wherein the intermediate member comprises a caul plate having a plurality of relatively rigid surface portions and a plurality of relatively deformable ties therebetween.

9. A method or system according to claim 6, wherein the displacement of each tool element is controlled to apply a corresponding pressure to an adjacent portion of the body, the displacement and/or pressure for each element being adjusted dynamically during debulking in response to one or more sensor readings so as to apply a non-uniform distribution over the body and thereby adjust the profile of the body between the first and second tools.

10. A method according to claim 1, wherein each element comprises an individually controllable heat source and the temperature of each element is set and/or adjusted to control a rate of consolidation/debulking of an adjacent portion of the body.

11. A method or system according to claim 10, wherein the heat source comprises a heater mat arranged to conduct heat to the tool surface.

12. A method according to claim 1, wherein the control of the individual element comprise setting an initial temperature or displacement or pressure value for each element and adjusting said values during debulking of said body.

13. A method according to claim 1, wherein a measurement device is arranged to determine one or more geometrical parameters of the body on the first tool prior to debulking, the temperature and/or displacement of said elements being controlled in response to the measurement of said geometrical parameter.

14. A method or system according to claim 13, wherein the measured value of the geometrical parameter is compared to a predetermined desired value of the geometrical parameter, the temperature and/or displacement of said elements being controlled in response to a difference between the measured and predetermined parameter values.

15. A method or system according to claim 13, wherein the measurement device determines a surface profile for said body.

16. A method or system according to claim 13, wherein one or more geometrical parameters of the body are measured between successive debulking processes.

17. A method or system according to claim 13, wherein the measurement device comprises a non-contact measuring tool, such as a scanner.

18. A method according to claim 1, wherein the matrix material comprises a curable material and the substrate comprises a fibre substrate.

19. A composite material manufacturing tool having:
an outer surface arranged to contact a deformable body comprising substrate and matrix materials in use;
an actuator for pressing said surface against said material, wherein the tool comprises a plurality of individually controllable tool elements; and
a controller arranged to control the temperature and/or displacement of said elements so as to generate a desired profile in said impregnated substrate material.

20. A tool according to claim 18, wherein the elements are discrete elements, which are individually actuatable within a two-dimensional array, each element having an associated actuator and heater.

21. (canceled)

22. A system according to claim 2, wherein the temperature, applied pressure and/or displacement of the individual tool elements is actively controlled according to an open or closed feedback loop.

23. A system according to claim 2, wherein the first and/or second tool comprises any, or any combination, of temperature, pressure and/or displacement sensors for the tool elements and the temperature and/or displacement of said elements is controlled based on readings of said sensors so as to actively adjust debulking of the impregnated substrate during heating thereof.

24. A system according to claim 2, wherein the plurality of tool elements comprise a two dimensional array of elements, each element corresponding to an area of the first or second tool surface.

25. A system according to claim 2, wherein the tool elements are individually actuatable so as to modify the shape of the surface of the first or second tool.

26. A method or system according to claim 25, wherein the surface of said first or second tool is provided by an intermediate member and the elements are individually actuatable to deform the intermediate member.

27. A method or system according to claim 26, wherein the intermediate member comprises a caul plate having a plurality of relatively rigid surface portions and a plurality of relatively deformable ties therebetween.

28. A method or system according to claim 25, wherein the displacement of each tool element is controlled to apply a corresponding pressure to an adjacent portion of the body, the displacement and/or pressure for each element being adjusted dynamically during debulking in response to one or more sensor readings so as to apply a non-uniform distribution over the body and thereby adjust the profile of the body between the first and second tools.

29. A system according to claim 2, wherein each element comprises an individually controllable heat source and the temperature of each element is set and/or adjusted to control a rate of consolidation/debulking of an adjacent portion of the body.

30. A method or system according to claim 29, wherein the heat source comprises a heater mat arranged to conduct heat to the tool surface.

31. A system according to claim 2, wherein the control of the individual element comprise setting an initial temperature or displacement or pressure value for each element and adjusting said values during debulking of said body.

32. A system according to claim 2, wherein a measurement device is arranged to determine one or more geometrical parameters of the body on the first tool prior to debulking, the temperature and/or displacement of said elements being controlled in response to the measurement of said geometrical parameter.

33. A method or system according to claim 32, wherein the measured value of the geometrical parameter is compared to a predetermined desired value of the geometrical parameter, the temperature and/or displacement of said elements being controlled in response to a difference between the measured and predetermined parameter values.

34. A method or system according to claim 32, wherein the measurement device determines a surface profile for said body.

35. A method or system according to claim 32, wherein one or more geometrical parameters of the body are measured between successive debulking processes.

36. A method or system according to claim 32, wherein the measurement device comprises a non-contact measuring tool, such as a scanner.

37. A system according to claim 2, wherein the matrix material comprises a curable material and the substrate comprises a fibre substrate.

38. A tool according to claim 37, wherein the elements are discrete elements, which are individually actuatable within a two-dimensional array, each element having an associated actuator and heater.
